(19) United States
(12) Patent Application Publication
(10) Pub. No.: US 2009/0003927 A1
(43) Pub. Date: Jan. 1, 2009

(54) BALL-AND-SOCKET JOINT BALL PIN WITH INJECTION MOLDED METAL BALL

(76) Inventors: James HOWES, Hermon, ME (US); Greg DAMBOISE, Brewer, ME (US); Thomas RICHTER, Damme (DE); Reinhard LEHRKE, Damme (DE); Frank BERSTERMANN, Hagen (DE); Arne SIEBE, Stemwede (DE)

Correspondence Address: MCGLEW & TUTTLE, PC, P.O. BOX 9227, SCARBOROUGH STATION, SCARBOROUGH, NY, 10510-9227, US

(21) Appl. No.: 11/769,231

(22) Filed: Jun. 27, 2007

(51) Int. Cl. B62D 7/16

(52) U.S. Cl. 403/131; 403/128

(57) ABSTRACT

A metallic ball pin of a ball-and-socket joint, preferably one with high load-bearing capacity, for motor vehicles with a surface ball part 22 containing grooves 60, 62 for receiving lubricant designed at one end of a pin member 10, 30, 40. To improve its functional properties and to reduce its manufacturing costs, a surface ball part 22 with a joint ball surface 25 is molded to a joint ball core portion 16 using an injection molding process.

### FIELD OF THE INVENTION

The present invention pertains to a ball pin of a ball-and-socket joint for a motor vehicle suspension and more particularly pertains to a ball pin (ball stud) with a joint ball provided with a molded surface.

### BACKGROUND OF THE INVENTION

Ball joints have been produced where the ball pin is a single-piece ball pin. These ball pins are prepared by cold forming steel material. Typically, machining and burnishing steps are required to achieve the final form of the ball pins. The production of such single-piece ball pins involves several manufacturing steps. The overall cost is significant including the steel. Further the manufacturing steps produce waste. This becomes more significant as material costs rise.

A two-piece ball pin has already being used in stabilizer applications. With such two-piece stabilizer ball pins the joint balls are press-fitted onto the ball stud creating a low load-bearing capacity. Such two-piece stabilizer ball pins would not be effective for automotive suspension ball joint applications due to the high pull-out requirements for a suspension ball joint.

A ball joint with a molded ball is known from German Offenlegungsschrift No. DE-A1 102 17 149. The ball joint ball is injection molded using plastic. The resulting structure that is metal and plastic can only carrying low loads. Further, problems are encountered based on the different rates of thermal expansion of the metal and plastic.

### SUMMARY OF THE INVENTION

It is the object of the present invention to provide a ball pin for ball joints with high load-bearing capacity, so as to particularly be useful in the suspension of a motor vehicle, which ball pin can be manufactured at low cost and which makes possible a high level of joint ball customization.

According to the invention, a metallic ball pin is provided for use in a ball joint in the suspension of motor vehicles. The ball pin has a pin member with a joint ball core portion on one end of the pin member and a pin end on the other. The pin member has a pin outer surface and a longitudinal axis. The joint ball core portion has a surface portion that extends radially outwardly with respect to the longitudinal axis of the pin member and with respect to an adjacent surface portion to create a core contour. The joint ball core portion is the region that receives and supports a ball surface part. The ball surface part is molded and formed around the joint ball core portion using an injection molding process. The injection molding process allows for material optimization in terms of strengths, machine-ability, and other material properties since a greater array of materials are available. The design of the ball pin using the injection molding process allows for two different distinct parts (the joint ball core portion and the ball surface part) to permanently attach making it possible to combine ball surface parts with different shaped pin members to create a modular system. Furthermore, this design results in considerably reducing manufacturing costs since machining of the ball pin is simplified and makes it possible to use variable pin diameters, which leads to longer service of the ball pin.

Metal or any other suitable material, particularly a zinc alloy, is injected into a mold release burr creating a joint ball surface that forms around the contour of the joint ball core portion of the pin member. When the material of the ball surface part is cooled, the ball surface part is nonrotatably attached to the joint ball core portion. The ball surface is inserted into a bearing shell of a housing of a ball and socket joint, which can be connected to another motor vehicle part or suspension part. The pin member may be prepared by cold forming and is formed of a metal or any other suitable material, particularly steel, that is different from the material used to form the joint ball surface. As the pin member is formed of a metal material, preferably steel, and the ball surface part is made of another material, preferably zinc, the thermal expansion is advantageously similar. The pin member is shaped for connection to a suspension part or a motor vehicle part.

The pin member advantageously includes a backing surface at the joint core portion. The backing surface may be a knurled surface or a similar holding function of a joint ball core region of the pin member providing a positive locking between the pin member and ball surface part material. The knurled surface includes surface portions that extend radially outwardly with respect to the longitudinal axis of the pin member and radially outwardly with respect to an adjacent core surface region. The joint ball core region may have a top surface portion perpendicular to a longitudinal axis of the pin member. Optionally, the ball surface part may or may not be in contact with the top surface of the joint ball core region. The joint ball core region may be mushroom shaped providing good positive locking. The joint ball core region may also be somewhat ball shaped with the molded or deposited outer material forming the ball bearing surface. Furthermore, the joint ball core region may have concave shaped side surfaces that transition to a flange edge for better positive locking. The joint ball core region may also have a circumferential side edge surface that extends substantially perpendicular to a longitudinal axis of the pin member to provide better positive locking.

By forming the ball as a molded surface, the various shape aspects of the outer surface may be controlled based on the mold used. The molded joint ball surface allows joint ball surfaces to be created with constant ball dimensions. Constant ball dimensions make it possible to considerably reduce the expense of machining and to improve the quality of the joint ball surface shape since secondary operations can be performed, such as induction hardening, prior to formation of the ball to help avoid heat distortion of the ball shape. Numerous features can also be incorporated into the injected areas, such as support rings for boots, seal grooves, and customized ball shapes, which can include equator clearances for torque control and grease grooves. Furthermore, both the ball surface part and the pin member are formed of a metallic metal and are therefore capable of being used in joints with high loading-bearing capacity. The joint ball may also be molded so that the outer surface has grooves for receiving lubricant. This allows for complicated lubricating grooves to be better prepared in the ball. The lubricant grooves may be straight, curved or extend helically over the shape of the joint ball.

According to the invention, a heat-shrinkable sleeve may be applied to the joint ball surface to form a ball shell. The heat-shrinkable sleeve is placed around the joint ball surface. The joint ball core portion is then subjected to heat causing the joint ball core portion to expand and to come in contact with the heat-shrinkable sleeve. The heat-shrinkable sleeve conforms to the shape of the joint ball surface and attaches to the joint surface. The flat areas of the heat-shrinkable sleeve attach to the top portion and the bottom portion of the joint ball surface. The heat-shrinkable sleeve being applied to the joint ball surface is advantageous as it avoids integrating the joint ball into a geometrically complicated ball shell. (We need more information on how this works so we can better describe it). Furthermore, the heat-shrinkable sleeve advantageously prevents rotation between the joint ball surface and the heat-shrinkable sleeve. The heat-shrinkable sleeve also reduces cost as it eliminates a ball shell that is normally found in such ball pins.

According to the invention, a method is contemplated for forming a pin member having a longitudinal axis and a pin end on one end of the pin member and a joint ball core portion on the other. The pin member is formed out of a metal material, preferably steel, and has a pin outer surface. The joint ball core portion has a core surface portion that extends radially outwardly with respect to the longitudinal axis and with respect to an adjacent surface portion to provide a core contour. The method further includes injection molding a second metal material, which is different from the metal material used to form the pin member, on the joint ball core portion to create a molded ball surface part. The ball surface part is in contact with the joint ball core and follows the core contour and the metal material of the ball surface part is on each axial side of the core surface portion.

According to the invention, the method further includes applying a heat-shrinkable sleeve to an outer metal surface of a joint ball core portion to create a ball shell. The heat-shrinkable sleeve is placed around the joint ball outer surface. The joint ball core region is then heated and expands as a result of the heating. As a result, the outer joint ball surface comes in contact with the heat-shrinkable sleeve and the heat-shrinkable sleeve conforms to the shape of the joint ball outer surface and attaches to the joint ball outer surface. Flattened areas of the heat-shrinkable sleeve attach parallel to the joint ball outer surface and advantageously act to prevent rotation between the heat-shrinkable sleeve and the joint ball core portion. The heat-shrinkable sleeve may be any suitable material, preferably plastic.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a side sectional view of a ball pin according to a first embodiment of the invention;

FIG. 2 is a side partially sectional view of a ball pin according to a second embodiment of the invention showing the outer knurled core surface of the pin member and showing the molded ball surface part in section;

FIG. 3 is a side partially sectional view of a ball pin according to a third embodiment of the invention showing an outer core surface of the pin member with radially outwardly extending portion with adjacent concave shaped sides and showing the molded ball surface part in section covering the radially outwardly extending portion and concave shaped sides;

FIG. 4 is a side view of the ball pin according to any of the embodiments of FIG. 1, FIG. 2, and FIG. 3 with a lubrication groove formed in the ball surface;

FIG. 5 is a perspective view of the ball pin of FIG. 4;

FIG. 6 is a side view of the ball pin according to FIG. 4 based on any of the embodiments of FIG. 1, FIG. 2, and FIG. 3 with a lubrication groove formed in the ball surface and with a heat-shrinkable sleeve shown in section before it is applied to the ball surface.

FIG. 7 is a side view showing the ball pin of FIG. 6 after the heat-shrinkable sleeve has been applied;

FIG. 8 is an enlarged view of the feature designated X in FIG. 7, depicting flattened areas of the heat-shrinkable sleeve applied on flat regions above and below the curved ball surface; and

FIG. 9 is a side view showing the ball pin of FIG. 7, depicting the ball pin with grooves for receiving lubricant after the heat-shrinkable sleeve has been applied and the ball surface having been placed within a bearing shell of a housing of a ball and socket joint and the pin end being connected to a suspension part or motor vehicle part (not shown).

### DESCRIPTION OF THE PREFERRED EMBODIMENTS

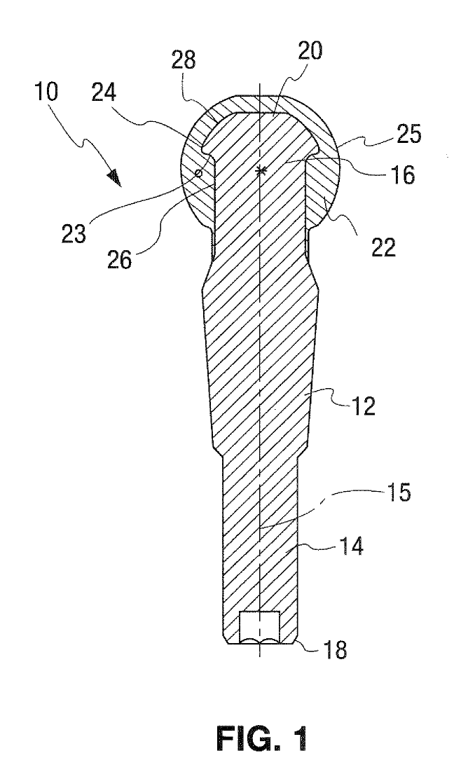

Referring to the drawings in particular, FIG. 1 shows a first embodiment according to the invention with a ball pin generally designated 10. The ball pin 10 comprises a pin member 12 having a pin (stud) portion 14 and a core portion 16. The pin member 12 extends from a pin end 18 to a ball end 20 and has a longitudinal axis 15. The pin member 12 is formed of a steel with a surface at the pin member 12 shaped for connection to a suspension part or motor vehicle part (not shown). The ball pin 10 has a ball surface part 22 made of a different material from the pin member 12. The ball surface part 22 provides the surface 25 of the ball of the ball pin 10. This ball surface is inserted into a bearing shell of a housing of a ball and socket joint, which can be connected to another motor vehicle part or suspension part (not shown).

The joint ball core portion 16 is the region that receives and supports the ball surface part 22. The ball surface part 22 is formed around the core portion using an injection molding process. When the material of the ball surface part 22 is cooled, the ball surface part 22 is nonrotatably attached to the joint ball core portion 16. As the pin member 12 is made of a metal material, preferably steel, and the ball surface part 22 is made of another metal material, preferably zinc, the thermal expansion is similar.

The joint ball core portion 16 has a top surface at the end 20 and a circumferential surface with a contour with an edge 24 that extends radially outwardly with respect to the longitudinal axis 15 of the pin member 12 and also radially outwardly of the adjacent core surface regions 26 and 28. The pin end side surface 23 of the edge surface 24 is almost perpendicular to the longitudinal axis 15 of the pin member 12. The ball surface part 22 contacts the joint ball core portion 16 and follows the contour based on the ball surface part 22 being molded thereto. With this construction, the core contour with side 23 of the edge surface 24 forms a positive lock with the ball surface part 22. A good connection is provided between the ball surface part 22 and the pin member 12 while also providing a desired shape for the ball joint surface 25.

The pin member 12 is manufactured with accurate dimensions according to the cold forming process. Constant ball dimensions make it possible to considerably reduce the expense of machining and to improve the quality of the ball surface part 22. Both the ball surface part 22 and the pin member 12 consist of a metallic material and are therefore particularly suitable for joints with high load-bearing capacity.

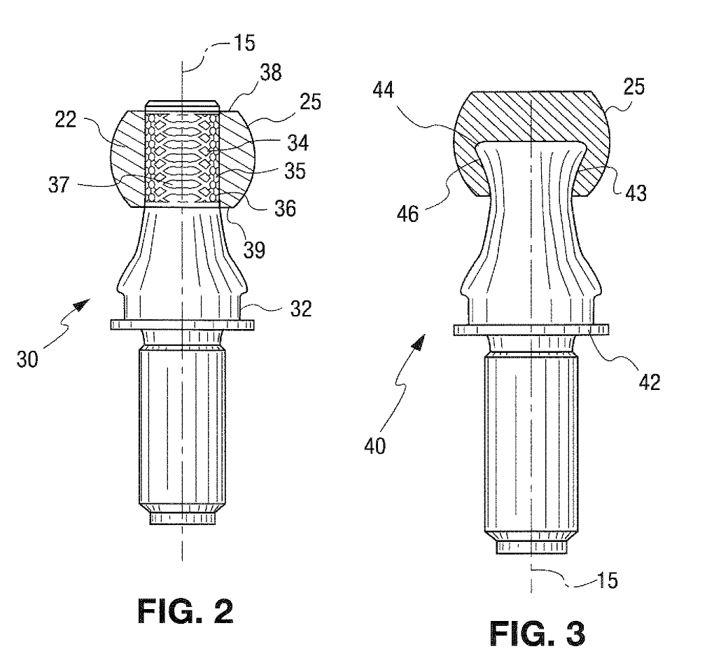

FIG. 2 shows a ball pin generally designated 30 that has an alternate design. A pin member 32 is modified compared with the pin member 12 represented in FIG. 1. The joint ball core portion 36 has a knurled surface 35 that includes surface portions 34 that extend radially outwardly with respect to the longitudinal axis 15 of the pin member 32 and also radially outwardly of the adjacent core surface regions 37. The surface portions 34 form a positive lock with the ball surface part 22. The knurled surface 35 allows for higher load-bearing capacity due to the better retention of the ball surface part 22 to the pin member 32.

FIG. 3 shows a ball pin generally designated 40 that has an alternate design. A pin member 42 is modified compared with the pin member 12 represented in FIG. 1. The pin member 42 has a joint ball core portion 46, with concave side surface 43. The concave side surface 43 transitions to a flange edge 44 that extends radially outwardly from the longitudinal axis 15 and radially outwardly from the adjacent concave side surface 43. The concave side surface 43 and the outwardly extending flange edge 44 provide for a positive lock with the ball surface part 22. The ball surface part 22 is molded to provide the ball surface 25.

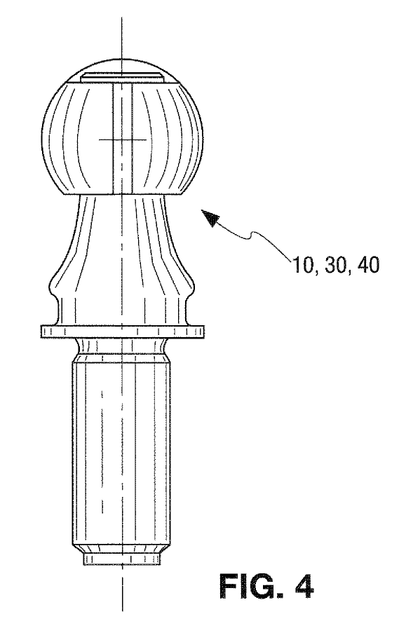

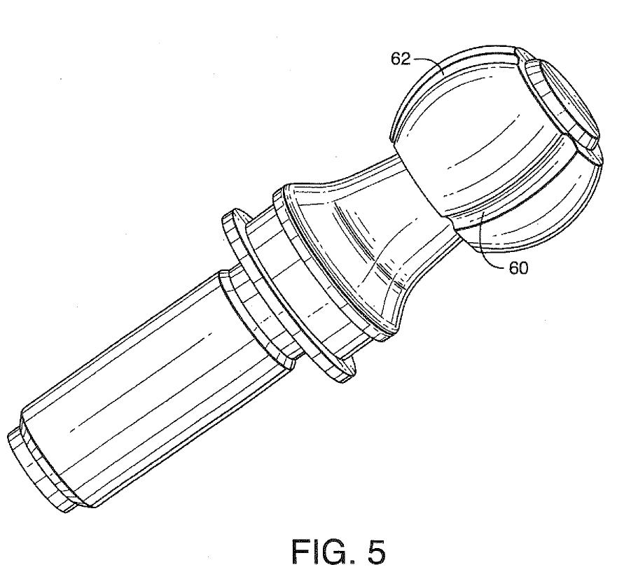

FIG. 4 shows a ball pin 10, 30, 40, that may be of the design shown in any of FIGS. 1-3. FIG. 5 shows the ball pin 10, 30, 40 showing two of the lubrication grooves 60, 62.

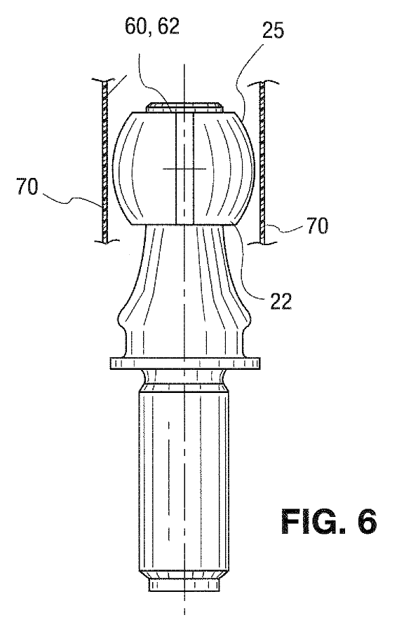

FIG. 6 shows means for applying a heat-shrinkable sleeve 70 to the joint ball surface 25, which creates a means to prevent rotation between the heat-shrinkable sleeve 70 and the joint ball surface 25. The heat-shrinkable sleeve 70 reduces cost as it eliminates a ball shell (not shown) that is typically found in such ball pins. The heat-shrinkable sleeve 70 is preferably extruded and greatly drawn. A heat supply (not shown) is applied causing the ball surface part 22 to expand and come in contact with the heat shrinkable sleeve 70. The heat shrinkable sleeve 70 engages the joint ball surface 25 and extends longitudinally down the joint ball surface 25. Grooves 60, 62 for receiving lubricant (not shown) are provided for on the joint ball surface 25, which are created on the joint ball surface 25 during the injection molding process.

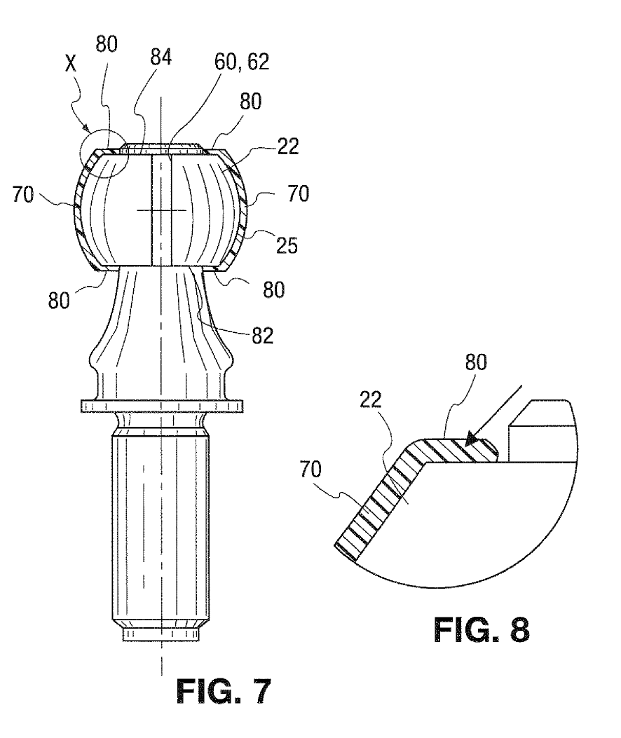

FIG. 7 shows the heat-shrinkable sleeve 70 after the ball surface part 22 has been heated. The flat areas 80 of the heat-shrinkable sleeve 70 attach to the top portion 84 and bottom portion 82 of the joint ball surface 25. This is shown particularly in FIG. 8 wherein it can be seen that the flat regions 80 allow for a better connection between the heat-shrinkable sleeve 70 and the ball surface part 22.

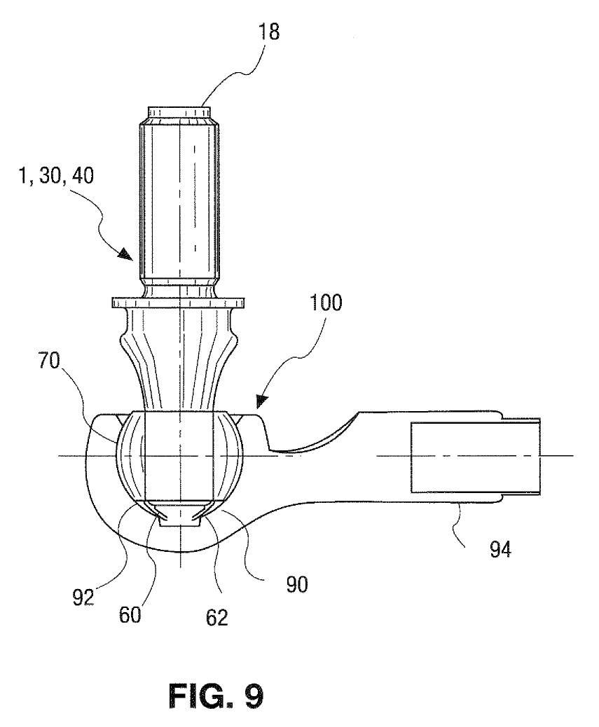

FIG. 9 shows the ball pin 10, 30, 40 with grooves 60, 62 and applied heat-shrinkable sleeve 70 having been placed in a bearing shell 92 of a housing 90 of a ball and socket joint generally designated 100, the joint housing having a link member, and the pin end 18 being connected to a suspension part or a motor vehicle part (not shown). While specific embodiments of the invention have been shown and described in detail to illustrate the application of the principles of the invention, it will be understood that the invention may be embodied otherwise without departing from such principles.

1. A metallic ball pin of a ball-and-socket joint for motor vehicles, the ball pin comprising:
a pin member having a longitudinal axis, said pin member being made of a metal material and having a pin portion with a pin outer surface and a pin end and having a joint ball core portion with a top surface portion and a surface portion extending radially outwardly with respect to a longitudinal axis and with respect to an adjacent surface portion to provide a core contour, said top surface extending continuously to form a closed end pin portion of said pin member; and
a ball surface part made of another metal material, said ball surface part being provided on said joint ball core in contact therewith and following said core contour and with said another metal material of said ball surface part on each axial side of said surface portion and said metal material of said pin member, said ball surface portion having a molded outer ball surface.

2. A metallic ball pin according to claim 1, wherein said ball surface part in contact with and following said joint ball core contour provides said another metal material of said ball surface part on each axial side of metal material of said pin member to form a positive lock between said pin member and said ball surface portion.

3. A metallic ball pin according to claim 1, wherein said top surface portion of said joint ball core portion is perpendicular to said longitudinal axis, said ball surface part being provided on said top surface portion of said joint ball core portion and being in contact therewith.

4-5. (canceled)

6. A metallic ball pin according to claim 1, wherein said core contour with said surface portion extending radially outwardly comprises an edge with an edge side surface extending substantially perpendicular to said longitudinal axis of said pin member.

7-16. (canceled)

17. A metallic ball pin of a ball-and-socket joint for motor vehicles, the ball pin compromising:
a pin member having a defined longitudinal axis, said pin member being made of a metal material, said pin member having a pin end, said pin member having a joint ball core surface to provide a joint ball core contour, said joint ball core surface including a top surface portion, a first joint ball core surface region, a second joint ball core surface region and a first edge joint ball core surface region, said first edge joint ball core surface region being adjacent to said first joint ball core surface region and said second joint ball core surface region, said first edge joint ball core surface region extending radially outwardly with respect to said longitudinal axis, said first joint ball core surface region and said second joint ball core surface region, said top surface portion extending continuously such that said top surface portion forms a closed end pin portion of said pin member, said top surface portion being perpendicular to said longitudinal axis, said pin member having a second edge surface region extending radially outward with respect to said longitudinal axis and said second joint ball core surface region, said second edge surface region being adjacent to said second joint ball core surface region;
a ball surface portion made of another metal material, said ball surface portion contacting said joint ball core surface and following and attaching to said joint ball core contour, said ball surface portion having an inner ball surface portion engaging said top surface, said first joint ball core surface region, said first edge joint ball core surface region and said second joint ball core surface region, said ball surface portion having a first axially extending portion and a second axially extending portion, said first axially extending portion being located adjacent to said first edge joint ball core surface region, said second axially extending portion being located adjacent to said second edge surface region, said ball surface portion having a molded outer ball surface forming a joint ball surface.

18. A metallic ball pin according to claim 17, wherein said top surface has a top surface diameter, said first edge joint ball core surface region having a first edge diameter, said first edge diameter being greater than said top surface diameter.

19. A metallic ball pin according to claim 17, wherein said first axially extending portion has a first portion diameter, said second axially extending portion having a second portion diameter, said first portion diameter being greater than said second portion diameter.

20. A metallic ball pin according to claim 17, wherein said second joint ball core surface region has a second joint ball core surface region diameter, said second edge surface region having a second edge surface region diameter, said second edge surface region diameter being greater than said second joint ball core surface region diameter.

21. A metallic ball pin according to claim 17, wherein said ball surface part in contact with and following said joint ball core contour provides said another metal material of said ball surface part on each axial side of metal material of said pin member to form a positive lock between said pin member and said ball surface portion.

22. A metallic ball pin according to claim 17, wherein said top surface portion of said joint ball core portion is perpendicular to said longitudinal axis.

23. A metallic ball pin according to claim 17, wherein said first joint ball core surface region comprises an edge with an edge side surface extending substantially perpendicular to said longitudinal axis of said pin member.

24. A metallic ball pin of a ball-and-socket joint for motor vehicles, the ball pin comprising:
a pin member having a longitudinal axis, said pin member being made of a metal material and having a pin portion with a pin outer surface and a pin end and having a joint ball core portion with a closed top surface portion and a surface portion extending radially outwardly with respect to a longitudinal axis and with respect to an adjacent surface portion to provide a core contour, said closed top surface portion having a closed top surface portion diameter, said surface portion having a surface portion diameter, said surface portion diameter being greater than said closed top surface portion diameter; and
a ball surface part made of another metal material, said ball surface part being provided on said joint ball core in contact therewith and following said core contour and with said another metal material of said ball surface part on each axial side of said surface portion and said metal material of said pin member, said ball surface portion having a molded outer ball surface.

25. A metallic ball pin according to claim 24, wherein said ball surface part in contact with and following said joint ball core contour provides said another metal material of said ball surface part on each axial side of metal material of said pin member to form a positive lock between said pin member and said ball surface portion.

26. A metallic ball pin according to claim 24, wherein said top surface portion of said joint ball core portion is perpendicular to said longitudinal axis, said ball surface part being provided on said top surface portion of said joint ball core portion and being in contact therewith.

27. A metallic ball pin according to claim 24, wherein said core contour with said surface portion extending radially outwardly comprises an edge with an edge side surface extending substantially perpendicular to said longitudinal axis of said pin member.
